(19) United States
(12) Patent Application Publication
(10) Pub. No.: US 2016/0365123 A1
(43) Pub. Date: Dec. 15, 2016

(54) METHOD AND ELECTRONIC DEVICE FOR VIDEO DEFINITION SWITCHING

(71) Applicants: Le Holdings (Beijing) Co., Ltd., Beijing (CN); LE SHI INTERNET INFORMATION TECHNOLOGY CORP. BEIJING, Beijing (CN)

(72) Inventors: Xi Wang, Beijing (CN); Linhu Wang, Beijing (CN)

(73) Assignees: Le Holdings (Beijing) Co., Ltd., Beijing (CN); LE SHI INTERNET INFORMATION TECHNOLOGY CORP. BEIJING, Beijing (CN)

(21) Appl. No.: 15/246,388

(22) Filed: Aug. 24, 2016

Related U.S. Application Data
(63) Continuation of application No. PCT/CN2015/089182, filed on Sep. 8, 2015.

(30) Foreign Application Priority Data
Nov. 18, 2014 (CN) 201410659769.4

(51) Int. Cl. G11B 27/10; G11B 20/12; G11B 27/00

(52) U.S. Cl. CPC G11B 27/105; G11B 27/005; G11B 20/1262; G11B 2020/1062

(57) ABSTRACT

Disclosed are a method and electronic device for video definition switching. The method comprises: loading a first fragment file of a first definition video from a pre-set second level cache region to a video stream cache region to be played; receiving a definition switching instruction; acquiring a configuration file of a second definition video from a video server according to the instruction; determining a second fragment file which corresponds to the first fragment file and meets a smooth switching condition in the second definition video; sequentially loading all fragment files arranged after the second fragment file in the second definition video to the second level cache region; and loading the fragment files to the video stream cache region after the first fragment file is played completely, and starting to play the second definition video.

### CROSS REFERENCE TO RELATED DISCLOSURES

This disclosure is a continuation of International Application No. PCT/CN2015/089182, filed on Sep. 8, 2015, which is based upon and claims priority to Chinese Patent Application No. 201410659769.4, filed on Nov. 18, 2014, the entire contents of which are incorporated herein by reference.

### TECHNICAL FIELD

The present disclosure relates to the video technology, and particularly to a method and electronic device for video definition switching.

### BACKGROUND

At present, people frequently watch their favorite video resources using a video player along with the development of network technologies. There are various definitions of the video resources, e.g., Normal, High Definition, and Ultra-High Definition, and the watchers can select the videos at the respective definitions for watching, where if a watcher changes to a video at a different definition, then this can be referred to as switching the definition of the video.

At present, the video player switches the definition typically by firstly stopping the video being played, and then loading the video at a new definition, jumping to the end time of the video, and playing the video, but such switching may result in discontinuous playing of the video, thus degrading the experience of the watching user.

### SUMMARY

The disclosure provides a method and electronic device for video definition switching so as to address the problem in the prior art of discontinuous playing of the video while the definition of the video is being switched.

In a first aspect, some embodiments of the disclosure provide a method for switching the definition of a video, the method comprising:

loading a first fragment file of the first definition video from a preset level-2 buffer area into a video stream buffer area for playing;

receiving a definition switching instruction to instruct the first definition video to be switched to the second definition video;

retrieving a configuration file of the second definition video from a video server in response to the received definition switching instruction, wherein the configuration file includes time information and address information of respective fragment files in the second definition video;

determining a second fragment file, satisfying a smooth switching condition, in the second definition video corresponding to the first fragment file according to the time information;

loading the respective fragment files in the second definition video ranked succeeding to the second fragment file into the level-2 buffer area sequentially according to the address information and the time information; and

loading the fragment files from the preset level-2 buffer area into the video stream buffer area, and to play the second definition video, after the first fragment file is played.

In a second aspect, some embodiments of the disclosure provide an electronic device including:

at least one processor; and

a memory communicably connected with the at least one processor for storing instructions executable by the at least one processor, wherein execution of the instructions by the at least one processor causes the at least one processor to:

load a first fragment file of a first definition video from a preset level-2 buffer area into a video stream buffer area for playing;

receive a definition switching instruction to instruct the first definition video to be switched to a second definition video;

retrieve a configuration file of the second definition video from a video server in response to the definition switching instruction received by the instruction receiving module, wherein the configuration file comprises time information and address information of respective fragment files in the second definition video;

determine a second fragment file, satisfying a smooth switching condition, in the second definition video corresponding to the first fragment file according to the time information;

load respective fragment files in the second definition video ranked succeeding to the second fragment file into the level-2 buffer area sequentially according to the address information and the time information; and

load the fragment files from the preset level-2 buffer area into the video stream buffer area, and to play the second definition video, after the first fragment file is played.

In a third aspect, some embodiments of the disclosure provide a non-transitory computer-readable storage medium storing executable instructions that, when executed by an electronic device, cause the electronic device to:

load a first fragment file of a first definition video from a preset level-2 buffer area into a video stream buffer area for playing;

receive a definition switching instruction to instruct the first definition video to be switched to a second definition video;

retrieve a configuration file of the second definition video from a video server in response to the definition switching instruction received by the instruction receiving module, wherein the configuration file comprises time information and address information of respective fragment files in the second definition video;

determine a second fragment file, satisfying a smooth switching condition, in the second definition video corresponding to the first fragment file according to the time information;

load respective fragment files in the second definition video ranked succeeding to the second fragment file into the level-2 buffer area sequentially according to the address information and the time information; and

load the fragment files from the preset level-2 buffer area into the video stream buffer area, and to play the second definition video, after the first fragment file is played.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is an architectural diagram of a system to which a method for switching the definition of a video according to some embodiments of the disclosure is applicable;

FIG. 2 is a schematic principle diagram of a method for switching the definition of a video according to some embodiments of the disclosure;

FIG. 3 is a schematic flow chart of a method for switching the definition of a video according to some embodiments of the disclosure;

FIG. 4 is a diagram of storage of fragment information in a method for switching the definition of a video according to some embodiments of the disclosure;

FIG. 5 is a schematic structural diagram of an electronic device according to some embodiments of the disclosure;

FIG. 6 is a schematic structural diagram of another electronic device according to some embodiments of the disclosure; and

FIG. 7 is a schematic structural diagram of a video playing system according to some embodiments of the disclosure.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

The embodiments of the disclosure will be described below in further details with reference to the drawings.

A video player is a client configured to play a video program, e.g., a LETV video player, a SOHU video player, etc., and if a user is currently watching his or her favorite entertainment program using some video player, where the entertainment program is being played with a normal version thereof, and the user is going to switch to a high-definition version thereof, then the user will click on a definition setting option in the video player, and select the “High Definition” level, then the video player will switch to play the entertainment program with the high-definition version for the user in response to the selection by the user. The video player will perform this switching process in a method for switching the definition of a video according to an embodiment of the disclosure particularly as follows:

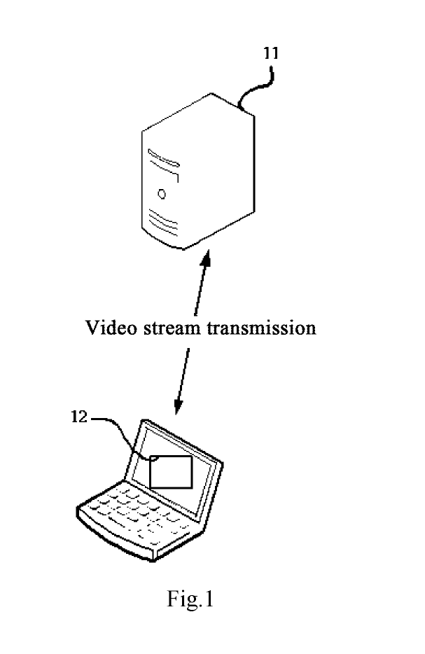

FIG. 1 illustrates an architectural diagram of a system to which a method for switching the definition of a video according to an embodiment of the disclosure is applicable, where cooperation and interaction between a video server and a video player (the video player can operate on an electronic device, such as a notebook computer of a user) is involved in an disclosure where the video player plays the video, a video program to be played by the video player is stored in the video server, and the video player downloads related data of the video program from the video server, and plays the video after decoding the data.

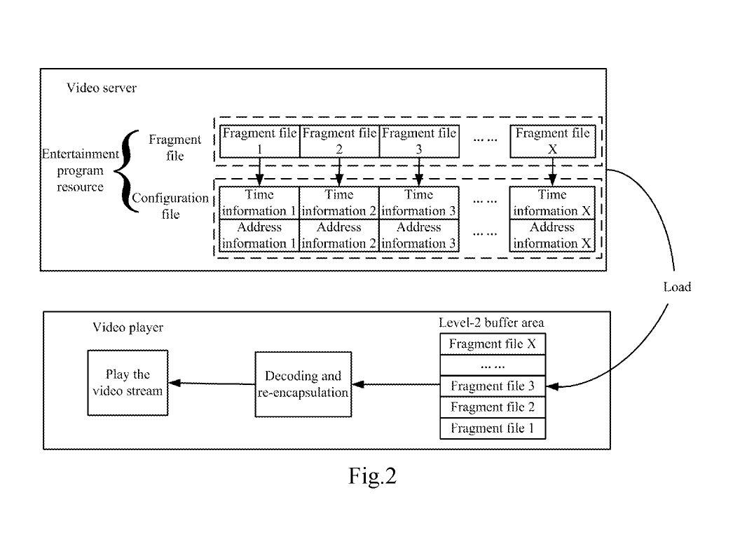

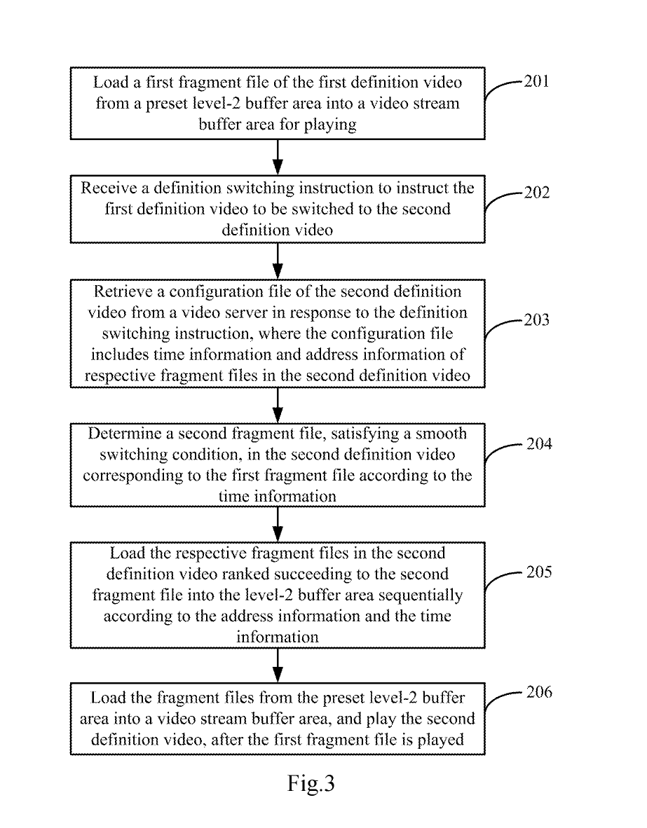

FIG. 2 outlines a principle of interaction between the video server and the video player to play the video program in the architecture of the disclosure system illustrated in FIG. 1, and as illustrated in FIG. 2, the video program can be stored in the server as two parts, and taking the above entertainment program as an example, the entertainment program is stored as two parts in the names of “fragment file” and “configuration file”, where the fragment files refer to a number of fragments into which the program is divided, for example, for a program with a length of 20 minutes, a video segment from the 1st second to the 10th second is a fragment file, a video segment from the 10th second to the 25th second is another fragment file, etc., where each fragment file includes video data of the video in the period of time; and the entertainment file is divided into X fragment files in an embodiment of the disclosure. Moreover the configuration file includes information about the fragment files, e.g., “time information 1” and “address information 1” corresponding to the fragment file 1, where the time information 1 refers to a start time and an end time of the fragment file 1 (for example, for the video segment from the 1st second to the 10th second, which is a fragment file as exemplified above, the start time of the fragment file is the 1st second), and the end time thereof is the 10th second, and the address information 1 refers to an address where the fragment file 1 is stored in the video server.

In an embodiment of the disclosure, the video player to play the entertainment program downloads the fragment files of the program from the video server, and buffers the fragment files into a level-2 buffer area in which fragment files which have been loaded but do not need to be imported into a video stream are stored. If the entertainment program needs to be played, the video player will retrieve the data from the level-2 buffer area, decode and re-encapsulate the data, and then import the data into the video stream for playing.

Further to the principle described above, a method for switching the definition of a video according to an embodiment of the disclosure includes the following operations:

In operation 201: loading a first fragment file of the first definition video from a preset level-2 buffer area into a video stream buffer area for playing;

In operation 202: receiving a definition switching instruction to instruct the first definition video to be switched to the second definition video;

In operation 203: retrieving a configuration file of the second definition video from a video server in response to the definition switching instruction, where the configuration file includes time information and address information of respective fragment files in the video at the second definition;

In operation 204: determining a second fragment file, satisfying a smooth switching condition, in the second definition video, corresponding to the first fragment file according to the time information;

In operation 205: loading the respective fragment files in the second definition video ranked succeeding to the second fragment file into the level-2 buffer area sequentially according to the address information and the time information; and

In operation 206: loading the fragment files from the preset level-2 buffer area into a video stream buffer area, and to play the second definition video, after the first fragment file is played.

The flow will be described below in further details: the level-2 buffer area is added to the video player in the embodiment of the disclosure in addition to the video stream buffer area; and the video player places in advance the fragment files, etc., retrieved from the video server, in the level-2 buffer area, and subsequently loads the fragment files from the level-2 buffer area into the video stream buffer area, and plays the video.

Particularly in the operation 201, for example, the video player is playing the first fragment file of the first definition video, where the first fragment file is loaded from the preset level-2 buffer area into the video stream buffer area for playing; and the first definition is “High Definition”, for example, and the high-definition video is also divided into a number of fragment files including the first fragment file being decoded and played.

In the operation 202, the video player receives the definition switching instruction to instruct the first definition video to be switched to the second definition video, where the second definition is “Ultra-High Definition”, for example, and of course, the user can alternatively switch from “Ultra-High Definition” to “High Definition”. In a particular implementation, the definition switching instruction can be issued by the user clicking on a definition option in the video player, and select a desired type of definition.

The video player requests the video server for the configuration file of the second definition video according to the second definition selected by the user. It shall be noted that configuration files of the video in versions at a number of definitions are typically stored at the video server side, e.g., Normal, High Definition, and Ultra-High Definition, and the corresponding configuration file is provided according to the definition selected by the user. In an embodiment of the disclosure, the video in the versions at the different definitions can be divided into the fragment files at the same granularity, for example, for the same video program, the video in the high-definition version thereof is divided into fragment files each with a length of 10 seconds (of course, the lengths of the time of the respective fragment files may be different), and the video in the ultra-high-definition version thereof is also divided into fragment files each with a length of 10 seconds; or the video in the versions at the respective definitions can be divided differently into fragment files as long as two fragments at the first definition and the second definition to be joined for switching can be temporally joined, as will be described below in the next operation 203.

Moreover it shall be noted that upon reception of the definition switching instruction above, the video player not only retrieves the configuration file of the second definition video from the video server but also stops the first definition video from being played, the related process on playing is as follows: stopping importing the other fragment files in the level-2 buffer area after the first fragment file of the first definition video into the video stream buffer area, and stopping the other fragment files of the first definition video from being loaded into the level-2 buffer area, that is, stopping the other fragment files of the first definition video than the fragment file being played from being further decoded and loaded. Particularly the following timer 1, timer 2, and timer 3 are disabled:

The timer 1 is configured to wait for all the fragments being decoded to be import into the video stream. The timer 1 operates in such a mechanism that if the first one of fragment files in the level-2 buffer area has no data readable, and this fragment file is a complete fragment which has been loaded, or there is not any fragment file in the level-2 buffer area, then it will be determined that all the fragments being decoded have been imported into the video stream, and the timer 1 will be disabled; otherwise, the operations above will be performed again.

The timer 2 is configured to control the video data to be decoded and imported into the video stream. The timer 2 operates in such a mechanism that if there are fragment data in the level-2 buffer area, then the first one of fragment files in the buffer area (the first fragment file here refers to a fragment file temporally ranked firstly in the level-2 buffer area) will be retrieved, and it will be determined whether the play start time of the fragment is later than the current play time by no more than 10 seconds; and if so, then the fragment data will be decoded, re-encapsulated, and imported into the video stream. Next if the fragment is a complete which has been loaded, and there are other fragments in the level-2 buffer area, then the fragment file will be removed from the buffer area. Then the operations above will be performed again.

The timer 3 is configured to control a new fragment file to be loaded. The timer 3 operates in such a mechanism that if there are fragment data in the level-2 buffer area, then the last one of fragment files will be retrieved from the buffer area. It is determined whether the play start time of the fragment is later than the current play time by no more than 60 seconds. If so, then the file data with the fragment number plus 1 will be loaded. Then the operations above are performed again.

Stated otherwise, the video player stops the first definition video from being played instead of further decoding and loading the first definition video upon reception of the definition switching instructions. However it shall be noted that the first fragment file of the first definition video being decoded will still be further decoded and played until the fragment ends, so that the first fragment file is being played all the time; and only the other fragment files of the first definition video in the level-2 buffer area will not be further decoded, and a new fragment file at the first definition will not be further loaded from the video server. Moreover processing of the configuration file information, loading of the second definition video, etc., in the subsequent operations are performed while the first fragment file is being played, and before the first fragment file play ends, the loading of the fragment files of the second definition video into the level-2 buffer area will be completed so that the second definition video can be further played immediately when the first fragment file play ends, thus resulting in continuity thereof.

After the video player retrieves the configuration file in the operation 203, in the operation 204, the video player determines whether the second definition video, and the first definition video being played satisfy the smooth switching condition, according to the configuration file of the second definition video, that is, whether the fragment files of the video at the two different definitions can be joined seamlessly. If so, then the operation 205 will be further performed to load the second definition video into the level-2 buffer area, and perform the switching when the first fragment file of the current first definition video play ends.

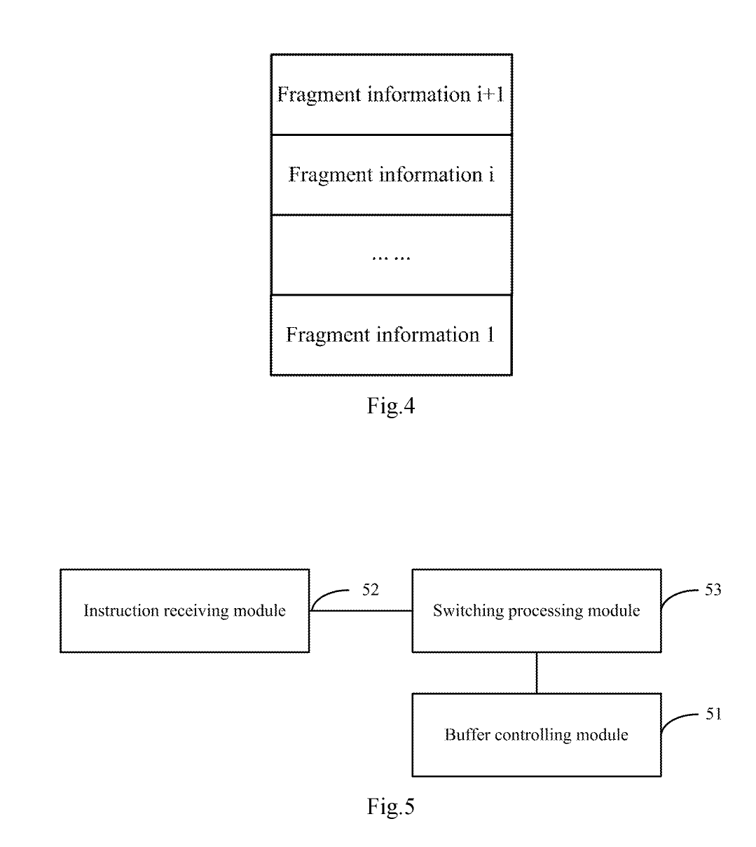

The determination against the smooth switching condition can be made particularly as follows: the video player generates a list of new definition fragments upon obtaining the configuration file, where the list of fragments is stored in the form of a vector array in which each element represents a piece of fragment information. Referring to FIG. 4, there are pieces of fragment information in the list, each of which includes time information and address information of a corresponding fragment file, for example, the fragment information i includes start time information and storage address information of the fragment file i.

The list of fragments is traversed, and it is firstly searched according to the time information for the second fragment file of the second definition video corresponding to the first fragment file being played, where it shall be noted that the retrieved respective fragment information can be stored as described above in a temporal order so that the efficiency of traversing the list of fragments can be improved. In an implementation of searching for the second fragment file can be as follows: comparing the start times of the respective fragments in the list of new definition fragments with the end time of the current fragment starting with the 0th fragment, and if the absolute value of the difference between the start time of the i-th fragment in the list of fragments, and the end time of the current fragment is less than or equal to the absolute value of the difference between the start time of the (i+1)-th fragment in the list of fragments, and the end time of the current fragment, then determining the fragment at the old definition being played corresponds to the (i−1)-th fragment in the list of new definition fragments, where the two fragment files correspond to each other so that the current play time lies in a period of time including the (i−1)-th fragment file.

For example, the start and end times of the fragment in the list of new definition fragments are 0-4th seconds, 4th-10th seconds, 10th-20th seconds, and 20th-25th seconds. If the end time of the current fragment is different from all the start times of the fragments in the list of fragments, then the smooth switching condition will not be satisfied for whichever value of i; and if the end time of the current fragment is the same as the start time of some fragment in the list of fragments, then if the end time of the current fragment is 10th second, then the difference between the start time of the 0th fragment in the list of fragments, and the end time of the current fragment is 10, and the difference between the start time of the 1st fragment, and the end time of the current fragment is 6, so 10>6 will not satisfy the condition; then the list of fragments will be traversed with i=1, and the calculation result will be 6>0 which still does not satisfy the condition; and furthermore the list of fragments will be traversed with i=2, and the calculation result will be 0<10 satisfying the condition, so it can be determined that the fragment being played corresponds to the (i−1)-th fragment in the list, i.e., the fragment from 4th to 10th seconds.

However for the sake of a convenient description, an example where the first fragment file being played corresponds to the i-th fragment file will be described throughout the following embodiments. When determining that the first fragment file being played corresponds to the second fragment file (the second fragment file) in the second definition video, the video player further determines whether the first fragment file and the i-th fragment file satisfy the smooth switching condition. If the end time of the first fragment file is the same as the end time of the second fragment file, then this will indicate that the smooth switching condition is satisfied, and the operation 204 will be further performed to load the second definition video.

For example, if both the periods of time of the first fragment file and the second fragment file are from the 10th second to the 25th second of the entertainment program, then both the end times of them are the 25th second; or if the period of time of the first fragment file is from the 15th second to the 25th second, and the period of time of the second fragment file is from the 10th second to the 25th second, then their start times will be different, but their end times will be the same, so the smooth switching condition will be satisfied, that is, the (i+1)-th fragment file can be joined seamlessly with the current first fragment file as long as the end time of the first fragment file is the same as that of the i-th fragment file.

Moreover it is also possible that the video player does not locate any second fragment file, satisfying the smooth switching condition, in the second definition video corresponding to the first fragment file, according to the time information, and in this case, the video player can search for a third fragment file in the first definition video temporally succeeding to the first fragment file, and determine a fourth fragment file, satisfying the smooth switching condition, in the second definition video corresponding to the third fragment file.

For example, if the period of time of the first fragment file is from the 10th second to the 20th second, and the next fragment file in the first definition video temporally ranked succeeding to the first fragment file is the third fragment file, then the period of time of the third fragment file will be from the 20th second to the 30th second; and if none of the respective fragment files in the second definition video is found with the same end time as the end time of the first fragment file, then it will be further determined whether there is a fragment file with the same end time as the end time of another succeeding fragment file to the first fragment file. For example (there is a fragment file with an end time which is the 30th second, among the fragment files of the second definition video), it may be determined that the end time of the third fragment file is the same as the end time of the fourth fragment file in the second definition video. The third fragment file and the fourth fragment file of the first definition video can be retrieved as described for retrieval of the fragment files of the second definition video, so a repeated description will be omitted here.

Then the video player can prolong the period of time for playing the first definition video, and after the current first fragment file is played, the video player will not switch to the second definition video, but will further play the third fragment file, and load the respective fragment files in the second definition video ranked succeeding to the fourth fragment file into the preset level-2 buffer area sequentially according to the address information and the time information. After the third fragment file is played, the fragment files are loaded from the preset level-2 buffer area into the video stream buffer area, and the second definition video is played. In this way, smooth switching from the first definition video to the second definition video can also be performed but with a slight delay in time. Furthermore it shall be noted that the third fragment file may not be a fragment file adjacent to the first fragment file, but may be one of the other respective fragment files ranked succeeding to the first fragment file.

If the video player determines that the first fragment file and the second fragment file do not satisfy the smooth switching condition as a result of comparison, then the video player will stop the first fragment file being played, load such a fragment file in the second definition video that has a period of time around the play end time of the current first fragment file, and relocate while playing the fragment file to thereby jump to the time when the first fragment file is currently stopped from being played, and further play the loaded fragment file. For example, if the video player determines that the two fragment files of the video at the respective definitions do not satisfy the smooth switching condition, where the current first fragment file is being played to the 25th second, then the video player will stop the first fragment file from being played at the 25th second (without waiting until the end time of the first fragment file), and if the video player determines that the period of time of the closest fragment file in the second definition video is from the 20th second to the 35th second, then the video player will load the fragment file, jump to the 25th second of the fragment file, and further play the fragment file.

If the first fragment file and the second fragment file satisfy the smooth switching condition, then the video player will perform the operation 205 to retrieve the address information of the respective succeeding fragment files to the second fragment file according to the configuration file of the second definition video, and to load the respective fragment files of the second definition video into the level-2 buffer area according to the address information.

Particularly after it is determined that smooth switching can be performed, the video player disables a timer 4 configured to reset a decoding and re-encapsulation plug-in, and then starts the timer 1 waiting for all the data of the current first fragment file to be decoded and imported into the video stream. Next the video player starts the timer 4 configured to reset the decoding and re-encapsulation plug-in, and clears the level-2 buffer area after the decoding and re-encapsulation plug-in is reset.

The decoding and re-encapsulation plug-in is configured to decode and convert in format the data in the fragment files of the level-2 buffer area into data which can be imported into the video stream for playing. For example, the decoding and re-encapsulation plug-in is an HLS re-encapsulation plug-in based upon open sources over the Internet, which is configured to re-encapsulate an M3U8 file into an FLU file.

The timer 4 is configured, if there are not any data in a decoding and re-encapsulation queue, or the first piece of data in the queue has no data readable, to clear the queue, and to reset the decoding and re-encapsulation plug-in; otherwise, to perform the operations above again.

Stated otherwise, the video player will not start a fragment loader to load the (i+1)-th fragment file of the second definition video, until the data in the first fragment file are decoded, where the (i+1)-th fragment file is an adjacent target fragment file ranked succeeding to the second fragment file. Particularly the video player can retrieve the address information of the target fragment file according to the configuration file, and load the second definition video into the level-2 buffer area starting with the target fragment file according to the address information, where the video is loaded starting with the target fragment file in such a way that the respective fragment files in the second definition video has its own address information, and the respective fragment files are downloaded according to the address information.

Here the respective fragment files in the second definition video ranked succeeding to the second fragment file can be loaded into the preset level-2 buffer area by loading the respective fragment files sequentially in an order of their time information, for example, the respective fragment files are loaded sequentially into the level-2 buffer area in an order that they are played, with the fragment file earliest in time being the first fragment file in the level-2 buffer area.

The timer 2, the timer 3, and a timer 5 configured to detect whether playing of the video at the new definition has started can be started on commencement of loading the fragment files of the second definition video. Stated otherwise, after the second definition video starts to be loaded from the video server, the normal play flow will commence so that after the downloaded fragment files of the second definition video are loaded, they will not be imported directly into the video stream, but will be firstly put into the level-2 buffer area; and in the mechanisms of the timer 2 and the timer 3, if the start time of the last fragment file in the level-2 buffer area is later than the current play time by no more than 1 minute, then the next new fragment file will be loaded, and if the available period of time for which the video stream being played is less than 10 seconds, then data will be requested from the level-2 buffer area. Also if the first one of fragment files in the level-2 buffer area is not the last fragment file in the buffer area, then this fragment file will be removed from the level-2 buffer area.

The timer 5 is configured, if the current play time exceeds the time recorded in a first data in a definition change queue, to determine that the video player has started playing of the second definition video, so that the video player can modify a User Interface (UI); otherwise, to perform the operations above again. Stated otherwise, upon detecting that the current play time has exceeded the end time of the first fragment file, the video player determines that playing of the second definition video has started, and modifies a video play interface to an interface corresponding to the second definition so that the video at the different definition can be displayed in the different play interfaces.

Here the definition change queue as referred above can be recorded by the video player upon reception of the definition switching instruction, and include the end time of the fragment file being played upon reception of the definition switching instruction (i.e., the time when the definition is going to be switched), and an identifier of the new definition to which the definition is switched, i.e., it is recorded in the definition change queue to which the definition is switched at some end time. The end time of the current fragment, and the identifier of the new definition can be recorded at the tail of the definition change queue.

If the user is switching the definition continuously, for example, the user choosing to switch current playing from “Normal” to “High Definition” due to an error in clicking may choose again to switch to “Ultra High Definition”, then it may have been recorded in the definition change queue that the end time of the current fragment corresponds to “High Definition”, and the player receiving “Ultra High Definition” may replace “High Definition” existing in the queue with recently received “Ultra High Definition”, terminate the last switching flow, and switch to the recently updated definition. With this change to the definition, the video player can retrieve the configuration file for recent “Ultra High Definition” from the video server, and determine whether the smooth switching condition is satisfied.

Moreover the timer 5 described above can instruct an interface display module of the video player to change the UI corresponding to the definition, upon detecting that playing of the second definition video is started; and in a real disclosure, the video player can alternatively modify the UI upon reception of the definition switching instruction. For example, the video player receiving the definition switching instruction can modify the value of a variable which is a switching flag to True indicating that there is an ongoing switching flow, and thus can modify the UI to display an interface indicating ongoing switching of the definition.

As can be apparent from the method for switching the definition of a video according to this embodiment, if the video player is switching from the first definition video to the second definition video in this method, then the current first fragment file of the first definition video being played will be decoded and played all the time; and before the first fragment file play ends, such a process will be performed that the configuration file of the second definition video is retrieved from the video server, it is determined from the configuration file that the two fragment files of the video at the respective definitions can be joined seamlessly, and the second fragment file of the second definition video is downloaded in advance into the level-2 buffer area; and when the first fragment file play ends, then the second fragment file will be further played.

There are three factors in this process: firstly the first definition video is being played all the time instead of being stopped; secondly the level-2 buffer area is set so that before the first definition video play ends, the second definition video has been loaded from the video server and put in advance into the buffer area; and thirdly the second fragment file of the second definition video, and the first fragment file of the first definition video can be temporally joined seamlessly without jumping in the prior art. These factors can ensure the definition of the video to be switched smoothly.

Further to the method above, an embodiment of the disclosure further provides an electronic device as illustrated in FIG. 5, which includes the following respective functional elements to perform the method above for switching the definition of a video. The electronic device includes a buffer controlling module 51, an instruction receiving module 52, and a switching processing module 53, where:

The buffer controlling module 51 is configured to load a first fragment file of the first definition video from a preset level-2 buffer area into a video stream buffer area for playing;

The instruction receiving module 52 is configured to receive a definition switching instruction to instruct the first definition video to be switched to the second definition video;

The switching processing module 53 is configured to retrieve a configuration file of the second definition video from a video server in response to the definition switching instruction received by the instruction receiving module 52, where the configuration file includes time information and address information of respective fragment files in the second definition video; and to determine a second fragment file, satisfying a smooth switching condition, in the second definition video corresponding to the first fragment file according to the time information; and

The buffer controlling module 51 is further configured to load the respective fragment files in the second definition video ranked succeeding to the second fragment file into the level-2 buffer area sequentially according to the address information and the time information; and to load the fragment files from the preset level-2 buffer area into a video stream buffer area, and to play the second definition video, after the first fragment file is played.

Furthermore the buffer controlling module 51 is further configured to stop the other fragment files in the level-2 buffer area succeeding to the first fragment file of the first definition video from being imported into the video stream buffer area, and to stop the other fragment files of the first definition video from being loaded into the level-2 buffer area, after the instruction receiving module 52 receives the definition switching instruction.

Furthermore the switching processing module 53 configured to determine the second fragment file, satisfying the smooth switching condition, in the second definition video corresponding to the first fragment file according to the time information is configured to determine the second fragment file with the same end time as the end time of the first fragment file.

Furthermore the switching processing module 53 is further configured, if no second fragment file, satisfying the smooth switching condition, in the second definition video corresponding to the first fragment file is located according to the time information, to search for a third fragment file in the first definition video temporally succeeding to the first fragment file, and to determine a fourth fragment file, satisfying the smooth switching condition, in the second definition video corresponding to the third fragment file.

The buffer controlling module 51 is further configured to load the respective fragment files in the second definition video ranked succeeding to the fourth fragment file into the preset level-2 buffer area sequentially according to the address information and the time information; and to load the fragment files from the preset level-2 buffer area into the video stream buffer area, and to play the second definition video, after the third fragment file is played.

Furthermore the buffer controlling module 51 configured to load the respective fragment files in the second definition video ranked succeeding to the second fragment file into the preset level-2 buffer area is configured to load the respective fragment files sequentially according to their time information.

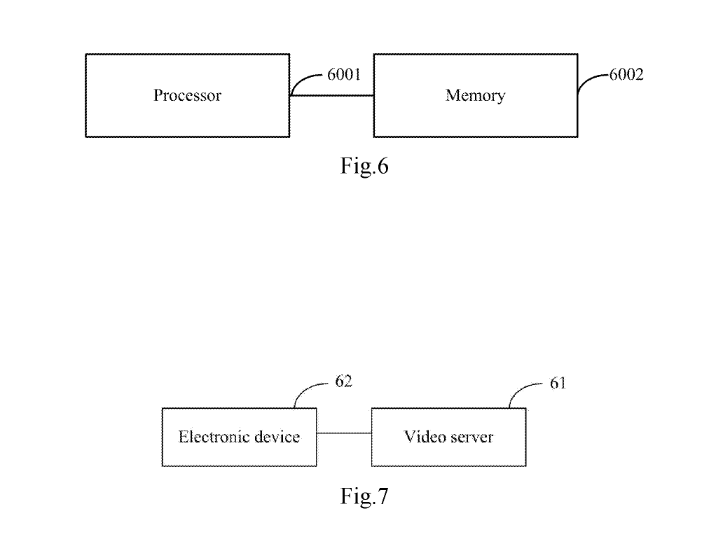

Based upon the same inventive idea, an embodiment of the disclosure further provides another electronic device as illustrated in FIG. 6 which is a schematic structural diagram of the device including:

At least one processor 6001 and a memory 6002, where there is one processor as an example in FIG. 6.

The memory 6002 is communicably connected with the at least one processor for storing instructions executable by the at least one processor, wherein execution of the instructions by the at least one processor causes the at least one processor to:

load a first fragment file of a first definition video from a preset level-2 buffer area into a video stream buffer area for playing;

receive a definition switching instruction to instruct the first definition video to be switched to a second definition video;

retrieve a configuration file of the second definition video from a video server in response to the definition switching instruction received by the instruction receiving module, wherein the configuration file comprises time information and address information of respective fragment files in the second definition video; and to determine a second fragment file, satisfying a smooth switching condition, in the second definition video corresponding to the first fragment file according to the time information; and

load respective fragment files in the second definition video ranked succeeding to the second fragment file into the level-2 buffer area sequentially according to the address information and the time information; and to load the fragment files from the preset level-2 buffer area into the video stream buffer area, and to play the second definition video, after the first fragment file is played.

In at least one embodiment, the execution of the instructions by the at least one processor further causes the at least one processor to: stop other fragment files in the level-2 buffer area succeeding to the first fragment file of the first definition video from being imported into the video stream buffer area, and stop the other fragment files of the first definition video from being loaded into the level-2 buffer area, after the instruction receiving module receives the definition switching instruction.

In at least one embodiment, the execution of the instructions by the at least one processor causes the at least one processor to determine the second fragment file, satisfying the smooth switching condition, in the second definition video corresponding to the first fragment file according to the time information by determining the second fragment file with a same end time as an end time of the first fragment file.

In at least one embodiment, the execution of the instructions by the at least one processor further causes the at least one processor to: if no second fragment file, satisfying the smooth switching condition, in the second definition video corresponding to the first fragment file is located according to the time information, search for a third fragment file in the first definition video temporally succeeding to the first fragment file, and determine a fourth fragment file, satisfying the smooth switching condition, in the second definition video corresponding to the third fragment file; and

load respective fragment files in the second definition video ranked succeeding to the fourth fragment file into the preset level-2 buffer area sequentially according to the address information and the time information; and load the fragment files from the preset level-2 buffer area into the video stream buffer area, and to play the second definition video, after the third fragment file is played.

In at least one embodiment, the execution of the instructions by the at least one processor causes the at least one processor to load the respective fragment files in the second definition video ranked succeeding to the second fragment file into the preset level-2 buffer area by loading the respective fragment files sequentially according to their time information.

The aforementioned electronic device can execute the method according to some embodiments of the disclosure, and has functional modules for executing corresponding method and advantageous thereof. For more technical details, the method according to some embodiments of the disclosure can be referred.

The electronic device according to some embodiments of the disclosure can be in multiple forms, which include but not limit to:

1. Mobile communication device, of which characteristic has mobile communication function, and briefly acts to provide voice and data communication. These terminals include smart pone (i.e. iPhone), multimedia mobile phone, feature phone, cheap phone and etc.

2. Ultra mobile personal computing device, which belongs to personal computer, and has function of calculation and process, and has mobile networking function in general. These terminals include PDA, MID, UMPC (Ultra Mobile Personal Computer) and etc.

3. Portable entertainment equipment, which can display and play multimedia contents. These equipments include audio player, video player (e.g. iPod), handheld game player, electronic book, hobby robot and portable vehicle navigation device.

4. Server, which provides computing services, and includes processor, hard disk, memory, system bus and etc. The framework of the server is similar to the framework of universal computer, however, there is a higher requirement for processing capacity, stability, reliability, safety, expandability, manageability and etc due to supply of high reliability services.

5. Other electronic devices having data interaction function.

Further to the method above, an embodiment of the disclosure further provides a video playing system as illustrated in FIG. 7, which includes a video server 61 and an electronic device 62, where the video server 61 is configured to store fragment files at different definitions of a video to be played, and a configuration file of the video, where the configuration file includes time information and address information of the respective fragment files in the video; and the electronic device 62 can be the one as illustrated in FIG. 5 or FIG. 6 above to perform the method above for switching the definition of a video.

Further to the method above, an embodiment of the disclosure further provides a non-transitory computer-readable storage medium storing executable instructions that, when executed by the electronic device, cause the electronic device to perform the above method for switching definition of a video.

Those ordinarily skilled in the art can appreciate that all or a part of the steps in the methods according to the embodiments described above can be performed by program instructing relevant hardware, where the programs can be stored in a computer readable storage medium, and the programs can perform one or a combination of the steps in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

1-11. (canceled)

12. A method for switching definition of a video, at an electronic device, the method comprising:
loading a first fragment file of a first definition video from a preset level-2 buffer area into a video stream buffer area for playing;
receiving a definition switching instruction to instruct the first definition video to be switched to a second definition video;
retrieving a configuration file of the second definition video from a video server in response to the received definition switching instruction, wherein the configuration file includes time information and address information of respective fragment files in the second definition video;
determining a second fragment file, satisfying a smooth switching condition, in the second definition video corresponding to the first fragment file according to the time information;
loading respective fragment files in the second definition video ranked succeeding to the second fragment file into the level-2 buffer area sequentially according to the address information and the time information; and
loading the fragment files from the preset level-2 buffer area into the video stream buffer area, and to play the second definition video, after the first fragment file is played.

13. The method according to claim 12, wherein after the definition switching instruction is received, the method further comprises:
stopping other fragment files in the level-2 buffer area succeeding to the first fragment file of the first definition video from being imported into the video stream buffer area, and stopping the other fragment files of the first definition video from being loaded into the level-2 buffer area.

14. The method according to claim 12, wherein the determining the second fragment file, satisfying the smooth switching condition, in the second definition video corresponding to the first fragment file according to the time information comprises:
determining the second fragment file with a same end time as an end time of the first fragment file.

15. The method according to claim 12, wherein the method further comprises:
if no second fragment file, satisfying the smooth switching condition, in the second definition video corresponding to the first fragment file is located according to the time information, then searching for a third fragment file in the first definition video temporally succeeding to the first fragment file, and determining a fourth fragment file, satisfying the smooth switching condition, in the second definition video corresponding to the third fragment file;
loading respective fragment files in the second definition video ranked succeeding to the fourth fragment file into the preset level-2 buffer area sequentially according to the address information and the time information; and
loading the fragment files from the preset level-2 buffer area into the video stream buffer area, and playing the second definition video, after the third fragment file is played.

16. The method according to claim 12, wherein the respective fragment files in the second definition video ranked succeeding to the second fragment file are loaded into the preset level-2 buffer area by loading the respective fragment files sequentially according to their time information.

17. An electronic device comprising:
at least one processor; and
a memory communicably connected with the at least one processor for storing instructions executable by the at least one processor, wherein execution of the instructions by the at least one processor causes the at least one processor to:
load a first fragment file of a first definition video from a preset level-2 buffer area into a video stream buffer area for playing;
receive a definition switching instruction to instruct the first definition video to be switched to a second definition video;
retrieve a configuration file of the second definition video from a video server in response to the definition switching instruction received by the instruction receiving module, wherein the configuration file comprises time information and address information of respective fragment files in the second definition video; and to determine a second fragment file, satisfying a smooth switching condition, in the second definition video corresponding to the first fragment file according to the time information; and
load respective fragment files in the second definition video ranked succeeding to the second fragment file into the level-2 buffer area sequentially according to the address information and the time information; and to load the fragment files from the preset level-2 buffer area into the video stream buffer area, and to play the second definition video, after the first fragment file is played.

18. The electronic device according to claim 17, wherein:
the execution of the instructions by the at least one processor further causes the at least one processor to: stop other fragment files in the level-2 buffer area succeeding to the first fragment file of the first definition video from being imported into the video stream buffer area, and stop the other fragment files of the first definition video from being loaded into the level-2 buffer area, after the instruction receiving module receives the definition switching instruction.

19. The electronic device according to claim 17, wherein:
the execution of the instructions by the at least one processor causes the at least one processor to determine the second fragment file, satisfying the smooth switching condition, in the second definition video corresponding to the first fragment file according to the time information by determining the second fragment file with a same end time as an end time of the first fragment file.

20. The electronic device according to claim 17, wherein:
the execution of the instructions by the at least one processor further causes the at least one processor to: if no second fragment file, satisfying the smooth switching condition, in the second definition video corresponding to the first fragment file is located according to the time information, search for a third fragment file in the first definition video temporally succeeding to the first fragment file, and determine a fourth fragment file, satisfying the smooth switching condition, in the second definition video corresponding to the third fragment file; and
load respective fragment files in the second definition video ranked succeeding to the fourth fragment file into the preset level-2 buffer area sequentially according to the address information and the time information; and load the fragment files from the preset level-2 buffer area into the video stream buffer area, and to play the second definition video, after the third fragment file is played.

21. The electronic device according to claim 17, wherein:
the execution of the instructions by the at least one processor causes the at least one processor to load the respective fragment files in the second definition video ranked succeeding to the second fragment file into the preset level-2 buffer area by loading the respective fragment files sequentially according to their time information.

22. A non-transitory computer-readable storage medium storing executable instructions that, when executed by an electronic device, cause the electronic device to:
load a first fragment file of a first definition video from a preset level-2 buffer area into a video stream buffer area for playing;
receive a definition switching instruction to instruct the first definition video to be switched to a second definition video;
retrieve a configuration file of the second definition video from a video server in response to the definition switching instruction received by the instruction receiving module, wherein the configuration file comprises time information and address information of respective fragment files in the second definition video;
determine a second fragment file, satisfying a smooth switching condition, in the second definition video corresponding to the first fragment file according to the time information;
load respective fragment files in the second definition video ranked succeeding to the second fragment file into the level-2 buffer area sequentially according to the address information and the time information; and
load the fragment files from the preset level-2 buffer area into the video stream buffer area, and to play the second definition video, after the first fragment file is played.

23. The non-transitory computer-readable storage medium according to claim 22, wherein:
the executable instructions when executed by an electronic device further cause the electronic device: stop other fragment files in the level-2 buffer area succeeding to the first fragment file of the first definition video from being imported into the video stream buffer area, and stop the other fragment files of the first definition video from being loaded into the level-2 buffer area, after the instruction receiving module receives the definition switching instruction.

24. The non-transitory computer-readable storage medium according to claim 22, wherein:
the executable instructions when executed by an electronic device cause the electronic device to determine the second fragment file, satisfying the smooth switching condition, in the second definition video corresponding to the first fragment file according to the time information by determining the second fragment file with a same end time as an end time of the first fragment file.

25. The non-transitory computer-readable storage medium according to claim 22, wherein:
the executable instructions when executed by an electronic device further cause the electronic device to: if no second fragment file, satisfying the smooth switching condition, in the second definition video corresponding to the first fragment file is located according to the time information, search for a third fragment file in the first definition video temporally succeeding to the first fragment file, and determine a fourth fragment file, satisfying the smooth switching condition, in the second definition video corresponding to the third fragment file; and
load respective fragment files in the second definition video ranked succeeding to the fourth fragment file into the preset level-2 buffer area sequentially according to the address information and the time information; and load the fragment files from the preset level-2 buffer area into the video stream buffer area, and to play the second definition video, after the third fragment file is played.

26. The non-transitory computer-readable storage medium according to claim 22, wherein:
the executable instructions when executed by an electronic device cause the electronic device to load the respective fragment files in the second definition video ranked succeeding to the second fragment file into the preset level-2 buffer area by loading the respective fragment files sequentially according to their time information.
